(19) United States
(12) Patent Application Publication
(10) Pub. No.: US 2026/0245770 A1
(43) Pub. Date: Aug. 20, 2026

(54) BUNCH INSULATED WIRE AND METHOD FOR MANUFACTURING THE SAME

(71) Applicant: Proterial, Ltd., Tokyo (JP)

(72) Inventors: Ryutaro KIKUCHI, Tokyo (JP); Yuki HONDA, Tokyo (JP); Minoru YAMADA, Tokyo (JP)

(21) Appl. No.: 19/374,692

(22) Filed: Oct. 30, 2025

(30) Foreign Application Priority Data
Feb. 14, 2025 (JP) 2025-022442
Sep. 19, 2025 (JP) 2025-156409

(51) Int. Cl. H01B 7/00; H01B 3/08; H01B 3/30

(52) U.S. Cl. CPC H01B 7/0045; H01B 3/081; H01B 3/30

(57) ABSTRACT

A bunch insulated wire includes a plurality of insulated element wire portions each having a conductor and an element wire coating that surrounds the conductor, and an insulating tape that collectively surrounds the plurality of insulated element wire portions, wherein the insulating tape has an insulating layer having electrical insulating properties and a fusion-bonding layer fused to the plurality of insulated element wire portions, and wherein the fusion-bonding layer is made of an engineering plastic or a super engineering plastic.

### CROSS-REFERENCE TO RELATED APPLICATIONS

The present application is based on Japanese patent application No. 2025-022442 filed on Feb. 14, 2025 and Japanese patent application No. 2025-156409 filed on Sep. 19, 2025, the entire contents of which are incorporated herein by reference.

### TECHNICAL FIELD

The present invention relates to a bunch insulated wire and a method for manufacturing a bunch insulated wire.

### BACKGROUND ART

Patent Literature 1 discloses an insulated wire as a bunch insulated wire constituting a segment coil of a motor for a vehicle. The insulated wire described in Patent Literature 1 includes a plurality of element wire portions having an element wire and a coating formed on an outer periphery of the element wire, and an insulating layer that covers the plurality of element wire portions.

### PATENT LITERATURE

Patent Literature 1: JP2021-141011A

### SUMMARY OF THE INVENTION

In the insulated wire described in Patent Literature 1, the insulating layer is formed by applying and heating a resin material on a surface of a laminate formed by laminating a plurality of element wire portions. Here, on the surface of the laminate to which the resin material is applied, there exist recesses at overlapping portions of the plurality of element wire portions. Therefore, when forming the insulating layer that covers the laminate, defects of the insulating layer are caused by air remaining in the recesses or by foaming occurring, whereby there is a possibility that the electrical insulating property of the insulated wire will decrease.

The present invention has been made in view of the above circumstances, and an object of the present invention is to provide a bunch insulated wire and a method for manufacturing a bunch insulated wire that can improve electrical insulating properties.

In order to achieve the above object, one aspect of the present invention provides a bunch insulated wire including: a plurality of insulated element wire portions each having a conductor and an element wire coating that surrounds the conductor; and an insulating tape that collectively surrounds the plurality of insulated element wire portions, the insulating tape having an insulating layer having electrical insulating properties and a fusion-bonding layer fused to the plurality of insulated element wire portions, the fusion-bonding layer being made of an engineering plastic or a super engineering plastic.

Further, in order to achieve the above object, another aspect of the present invention provides a method for manufacturing a bunch insulated wire, the method including: preparing a plurality of insulated element wire portions each having a conductor and an element wire coating that surrounds the conductor, and an insulating tape having an insulating layer having electrical insulating properties and a fusion-bonding layer made of an engineering plastic or a super engineering plastic, the fusion-bonding layer being fused to the plurality of insulated element wire portions; laterally winding the insulating tape so as to collectively surround the plurality of insulated element wire portions; and by an induction heating method, bonding the fusion-bonding layer of the insulating tape to each of the plurality of insulated element wire portions.

### Advantageous Effects of the Invention

According to the present invention, it becomes possible to provide a bunch insulated wire and a method for manufacturing a bunch insulated wire that can improve electrical insulating properties.

### BRIEF DESCRIPTION OF DRAWINGS

FIG. 1 is a perspective view of a bunch insulated wire according to a first embodiment.

FIG. 2 is a cross-sectional view of the bunch insulated wire according to the first embodiment.

FIG. 3 is a cross-sectional view of the bunch insulated wire according to the second embodiment.

FIG. 4 is across-sectional view of the bunch insulated wire according to the third embodiment.

FIG. 5 is a cross-sectional view of the bunch insulated wire according to the fourth embodiment.

FIG. 6 is a cross-sectional view of the bunch insulated wire according to the fifth embodiment.

FIG. 7 is a cross-sectional view of the bunch insulated wire according to the sixth embodiment.

FIG. 8 is a cross-sectional view of the bunch insulated wire according to the seventh embodiment.

FIG. 9 is a cross-sectional view of the bunch insulated wire according to the eighth embodiment.

FIG. 10 is a cross-sectional view of the bunch insulated wire according to the ninth embodiment.

FIG. 11 is a schematic diagram for illustrating a heating step in the ninth embodiment.

FIG. 12 is a first figure for explaining a method of evaluating adhesiveness in Experimental

### Example 2.

FIG. 13 is a second figure for explaining a method of evaluating adhesiveness in Experimental Example 2.

### DETAILED DESCRIPTION OF THE EMBODIMENTS

### First Embodiment

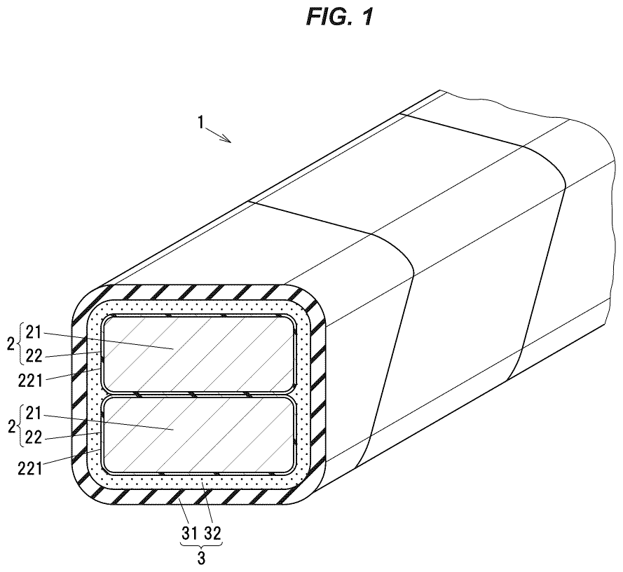

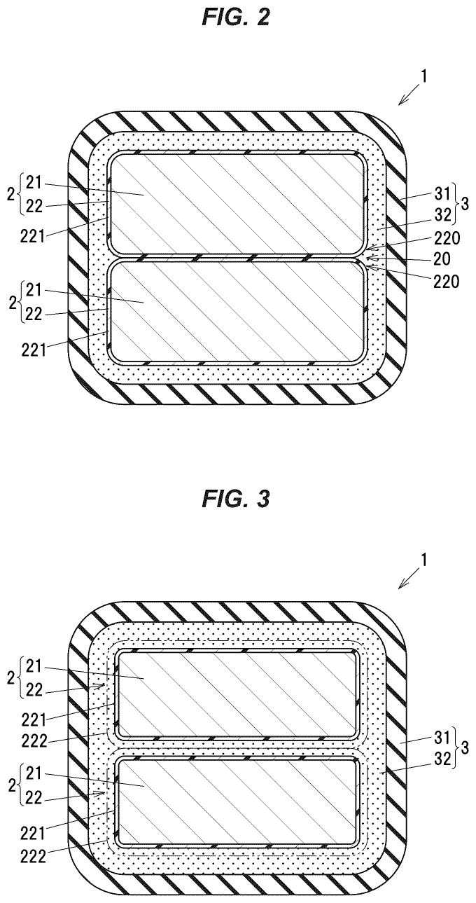

A first embodiment of the present invention will be described with reference to FIGS. 1 and 2.

Note that the embodiment described below is shown as a suitable concrete example for carrying out the present invention, and although parts thereof specifically exemplify various technically preferable technical matters, the technical scope of the present invention is not limited to this specific aspect.

FIG. 1 is a perspective view of a bunch insulated wire 1 in this embodiment. FIG. 2 is a cross-sectional view of the bunch insulated wire 1 in this embodiment. FIG. 2 shows a cross section of the bunch insulated wire 1 orthogonal to the longitudinal direction. Note that, when simply referring to the “longitudinal direction,” it is to be understood as the longitudinal direction of the bunch insulated wire 1.

The bunch insulated wire 1 of this embodiment includes a plurality of insulated element wire portions 2 and an insulating tape 3. Each insulated element wire portion 2 has a conductor 21 and an element wire coating 22 that surrounds the conductor 21. The insulating tape 3 collectively surrounds the plurality of insulated element wire portions 2. The insulating tape 3 has an insulating layer 31 having electrical insulating properties and a fusion-bonding layer 32 that is formed on an inner surface of the insulating layer 31 and fused to the plurality of insulated element wire portions 2. The fusion-bonding layer 32 is made of an engineering plastic or a super engineering plastic. The bunch insulated wire 1 of this embodiment will be described in detail below.

In this embodiment, the bunch insulated wire 1 includes two insulated element wire portions 2, that is, not more than four, specifically two. As the number of insulated element wire portions 2 included in the bunch insulated wire 1 increases, a space-occupation ratio, which is the ratio of the conductor 21 in the installation space where the bunch insulated wire 1 is disposed, tends to decrease; from this viewpoint, the number of the insulated element wire portions 2 is preferably not more than four, and more preferably not more than two. However, the number of insulated element wire portions 2 included in the bunch insulated wire 1 may exceed four. Each insulated element wire portion 2 is a flat, rectangular wire. The two insulated element wire portions 2 are laminated with their thickness directions coinciding and stacked with each other in the thickness direction. Note that the insulated element wire portion 2 is not limited to a rectangular wire; for example, a circular cross-section is also acceptable; however, from the viewpoint of increasing the space-occupation ratio, a rectangular wire is preferable.

The conductor 21 of the insulated element wire portion 2 is a flat rectangular conductor having a cross-sectional shape perpendicular to the longitudinal direction that is rectangular. The conductor 21 is made of, for example, a metal material such as pure copper, a copper alloy, aluminum, or an aluminum alloy. A metal plating such as nickel plating may be provided on the surface of the conductor 21.

The element wire coating 22 includes an element wire insulating layer 221. In this embodiment, the element wire coating 22 consists of the element wire insulating layer 221 that is in contact with the conductor 21. The element wire insulating layer 221 is an enamel coating formed of a thermosetting resin having electrical insulating properties, such as polyamide-imide (PAI) or polyimide (PI). Note that, in this embodiment, as long as it is formed adjacent to the conductor 21 and has electrical insulating properties, the element wire insulating layer 221 need not be an enamel coating. For example, the element wire insulating layer 221 may be an oxide film made of an oxide of the conductor 21 formed on the surface of the conductor 21.

Corner portions 220 (see FIG. 2) of the surface of the element wire coating 22 are unavoidably formed in a curved-surface shape. Accordingly, in a state where the two insulated element wire portions 2 are laminated, recesses 20 (see FIG. 2) are unavoidably formed on a surface of a laminate of the plurality of insulated element wire portions 2 by the corner portions 220 facing each other.

Here, consideration is given to a case where the outermost layer is formed by applying and heating a resin material on the surface of a laminate in which a plurality of insulated element wire portions 2 are laminated (for example, the invention described in Patent Literature 1 mentioned above). In this case, at the time of application of the resin material, air may be left in the recesses 20, and at the time of heating, foaming may occur from the portions of the recesses 20, with the result that there is a possibility that the electrical insulating property of the finished product will decrease. Therefore, in this embodiment, by adopting a configuration in which the plurality of insulated element wire portions 2 are covered with the insulating tape 3, a decrease in the electrical insulating property of the bunch insulated wire 1 is suppressed.

As shown in FIG. 1, the insulating tape 3 is wound helically (laterally wound) around the plurality of insulated element wire portions 2. In this embodiment, the insulating tape 3 is wound around the plurality of insulated element wire portions 2 so that portions of the tape do not overlap each other. Specifically, the insulating tape 3 is wound by so-called butt winding in which end portions in the width direction of the insulating tape 3 abut each other. As a result, compared with the case where the winding method of the insulating tape 3 is lap winding in which the end portions in the width direction of the insulating tape 3 are overlapped while winding, the thickness of the insulating tape 3 is made uniform in the longitudinal direction. Thus, the electrical insulating property provided by the insulating tape 3 is made uniform in the longitudinal direction and miniaturization is achieved. Note that the winding method of the insulating tape 3 is not limited to butt winding; lap winding or longitudinal application is also acceptable. When the insulating tape 3 is lap-wound, it is preferable that the lap width be one-half or less of the tape width. A plurality of insulating tapes 3 may be used to form the insulating tape 3 in multiple layers.

The insulating layer 31 of the insulating tape 3 is made of, for example, an engineering plastic or a super engineering plastic having heat resistance and electrical insulating properties, such as polyimide (PI), polyether-ether-ketone (PEEK), polyphenylene sulfide (PPS), polyetherimide (PEI), or thermoplastic polyimide (TPI). The insulating layer 31 is preferably a thermosetting resin such as thermosetting polyimide, but may be a thermoplastic resin. When the insulating layer 31 is a thermoplastic resin, it is preferable that the insulating layer 31 have a higher melting point than the fusion-bonding layer 32.

The fusion-bonding layer 32 is formed on an inner surface of the insulating layer 31 and is fused to each of the plurality of insulated element wire portions 2. As a result, the relative positions of the plurality of insulated element wire portions 2 are fixed. The fusion-bonding layer 32 is made of an engineering plastic or a super engineering plastic which is a thermoplastic resin having heat resistance and electrical insulating properties. For example, it is preferable that the melting point of the fusion-bonding layer 32 be 250° C. or higher. When the fusion-bonding layer 32 is made of a material having no melting point, it is preferable that the melt-processable temperature be 250° C. or higher. Specifically, the fusion-bonding layer 32 is made of a material including a fluororesin, polyether-ether-ketone (PEEK), polyphenylene sulfide (PPS), thermoplastic polyimide (PI), or polyetherimide (PEI). As the fluororesin, for example, perfluoroethylene propylene copolymer (FEP), perfluoroalkoxy alkane polymer (PFA), polytetrafluoroethylene (PTFE), or ethylene-tetrafluoroethylene copolymer (ETFE) can be used. Since the bunch insulated wire 1 may be exposed to high temperatures due to heat generation by energization, it is desirable that the fusion-bonding layer 32 not melt at high temperatures. From the viewpoint of improving the electrical insulating property of the insulating tape 3, the fusion-bonding layer 32 may be formed so as to have a thickness of 10 μm or more. The total thickness of the insulating tape 3 can be, for example, 10 μm or more and 200 μm or less. Note that, in this embodiment, an example is shown in which the insulating tape 3 has the insulating layer 31 and, as a separate layer from the insulating layer 31, the fusion-bonding layer 32 formed on the inner surface of the insulating layer 31, that is, a multilayer structure; however, the invention is not limited thereto, and a single layer that serves as both the insulating layer 31 and the fusion-bonding layer 32 may be used.

The bunch insulated wire 1 of this embodiment is used, for example, as a constituent component of a segment coil that is mounted in a slot of a stator core of a motor for a vehicle. In this case, the bunch insulated wire 1 is used after being bent into the shape of the segment coil (for example, a substantially U shape). When the bunch insulated wire 1 is for a motor segment coil, heat generation during use tends to become significant and extremely high heat resistance is required. As described above, in the bunch insulated wire 1 of this embodiment, the heat resistance of the insulating tape 3 is increased, and it is suitably used for a motor segment coil.

In manufacturing the bunch insulated wire 1 of this embodiment, first, the two insulated element wire portions 2 and the insulating tape 3 are prepared. Then, the two insulated element wire portions 2 are laminated in the thickness direction in an attitude where the thickness directions coincide, to form a laminate. Then, the insulating tape 3 is wound around the laminate, and by heating the whole, the fusion-bonding layer 32 and the two insulated element wire portions 2 are fused together. Thus, the bunch insulated wire 1 of this embodiment can be manufactured.

### Operation and Effects of the First Embodiment

In the bunch insulated wire 1 of this embodiment, the insulating tape 3 that collectively surrounds the plurality of insulated element wire portions 2 has the insulating layer 31 having electrical insulating properties and the fusion-bonding layer 32 that is formed on an inner surface of the insulating layer 31 and is fused to the plurality of insulated element wire portions 2. Here, in a case where an outermost layer is formed by applying and heating a resin material on a surface of a laminate in which a plurality of insulated element wire portions 2 are laminated (for example, the invention described in Patent Literature 1 mentioned above), at the time of application of the resin material, air may be left in the recesses 20, and at the time of heating, foaming may occur from the portions of the recesses 20, with the result that there is a possibility that the electrical insulating property of the finished product will decrease. Therefore, in this embodiment, the plurality of insulated element wire portions 2 are covered with the insulating tape 3. As a result, a decrease in the electrical insulating property of the bunch insulated wire 1 is suppressed. Furthermore, the fusion-bonding layer 32 of the insulating tape 3 is made of an engineering plastic or a super engineering plastic. Therefore, it is suppressed that, due to heat during use of the bunch insulated wire 1, the fusion-bonding layer 32 deteriorates or changes, thereby decreasing the electrical insulating property of the bunch insulated wire 1.

Moreover, since the fusion-bonding layer 32 is made of a material including a fluororesin, PEEK, PPS, PI, or PEI, the heat resistance of the fusion-bonding layer 32 is further improved.

Further, the insulating tape 3 is formed so that its portions do not overlap each other. Therefore, the thickness of the insulating tape 3 is made uniform in the longitudinal direction. Thus, the electrical insulating property provided by the insulating tape 3 is made uniform in the longitudinal direction, and miniaturization of the entire bunch insulated wire 1 is achieved.

Further, the plurality of insulated element wire portions 2 are not more than four. Since, as the number of insulated element wire portions 2 included in the bunch insulated wire 1 increases, the space-occupation ratio (the ratio of the conductor 21 in the installation space where the bunch insulated wire 1 is disposed) tends to decrease, by making the number of the plurality of insulated element wire portions 2 not more than four, the space-occupation ratio is improved.

As described above, according to this embodiment, it is possible to provide a bunch insulated wire capable of improving electrical insulating properties.

### Second Embodiment

A second embodiment of the present invention will be described with reference to FIG. 3. FIG. 3 is a cross-sectional view of the bunch insulated wire 1.

This embodiment is a form in which the element wire coating 22 is changed relative to the first embodiment. Specifically, the element wire coating 22 of this embodiment further includes an outer element wire fusion-bonding layer 222 formed on an outer side of the element wire insulating layer 221. The element wire insulating layer 221 is the same as in the first embodiment.

The outer element wire fusion-bonding layer 222 is made of an engineering plastic or a super engineering plastic which is a thermoplastic resin having heat resistance and electrical insulating properties. For example, it is preferable that the melting point be 250° C. or higher. When the outer element wire fusion-bonding layer 222 is made of a material having no melting point, it is preferable that the melt-processable temperature be 250° C. or higher. Specifically, the outer element wire fusion-bonding layer 222 is made of a material including a fluororesin, polyether-ether-ketone (PEEK), polyphenylene sulfide (PPS), thermoplastic polyimide (PI), or polyetherimide (PEI). As the fluororesin, for example, perfluoroethylene propylene copolymer (FEP), perfluoroalkoxy alkane polymer (PFA), polytetrafluoroethylene (PTFE), or ethylene-tetrafluoroethylene copolymer (ETFE) can be used. Since the bunch insulated wire 1 may be exposed to high temperatures due to heat generation by energization, it is desirable that the outer element wire fusion-bonding layer 222 not melt at high temperatures. Note that, after fusion-bonding, the boundary of the outer element wire fusion-bonding layer 222 is not necessarily clearly observable; in FIG. 3, the contour position of the outer element wire fusion-bonding layer 222 before fusion-bonding is indicated by a chain double-dashed line.

The outer element wire fusion-bonding layers 222 of the plurality of insulated element wire portions 2 are fixed to each other by mutual fusion-bonding. Further, the outer element wire fusion-bonding layers 222 of the plurality of insulated element wire portions 2 are also fused to the fusion-bonding layer 32 of the insulating tape 3.

In manufacturing the bunch insulated wire 1 of this embodiment, first, the two insulated element wire portions 2 and the insulating tape 3 are prepared. Each insulated element wire portion 2 is obtained, for example, by forming the element wire insulating layer 221 by applying and heating a resin material that becomes the element wire insulating layer 221 on the conductor 21, and thereafter forming the outer element wire fusion-bonding layer 222 by applying and heating a resin material that becomes the outer element wire fusion-bonding layer 222 on the element wire insulating layer 221. Then, the two insulated element wire portions 2 are laminated in the thickness direction in an attitude where the thickness directions coincide to form a laminate. Thereafter, by heating the laminate, the outer element wire fusion-bonding layers 222 of the two insulated element wire portions 2 are fused to each other. Thus, the relative positions of the two insulated element wire portions 2 are fixed. Next, the insulating tape 3 is wound around the two insulated element wire portions 2, and by heating the whole, the fusion-bonding layer 32 and the outer element wire fusion-bonding layers 222 of the two insulated element wire portions 2 are fused together. Thus, the bunch insulated wire 1 of this embodiment can be manufactured.

Other configurations of this embodiment are the same as those of the first embodiment. Among the reference numerals used from the second embodiment onward, those identical to those used in the previously described embodiments represent the same components unless otherwise indicated.

### Operation and Effects of the Second Embodiment

In this embodiment, the outer element wire fusion-bonding layers 222 of the plurality of insulated element wire portions 2 are fused to each other. Therefore, displacement of positions among the plurality of insulated element wire portions 2 is suppressed. Other operations and effects are the same as those of the first embodiment.

### Third Embodiment

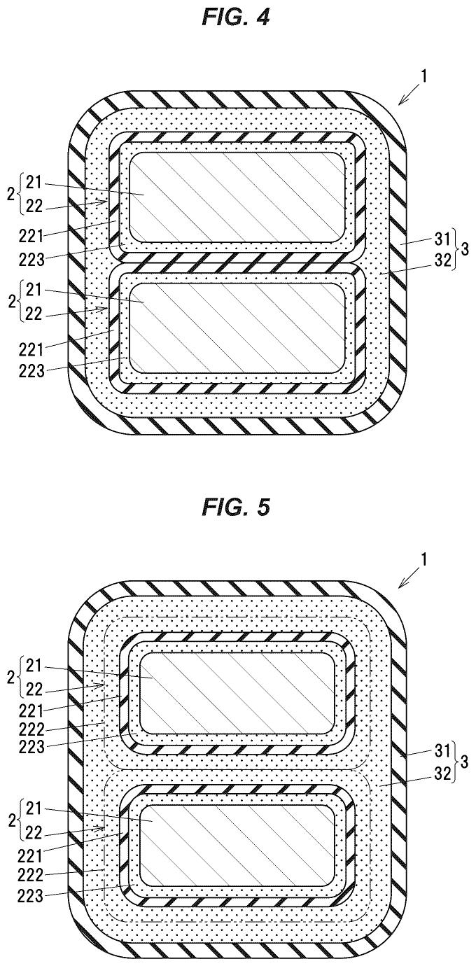

A third embodiment of the present invention will be described with reference to FIG. 4. FIG. 4 is a cross-sectional view of the bunch insulated wire 1.

This embodiment is a form in which the element wire coating 22 is changed relative to the first embodiment. Specifically, the element wire coating 22 of this embodiment is configured of a tape. The element wire coating 22 of this embodiment includes the element wire insulating layer 221 and an inner element wire fusion-bonding layer 223 that is formed on an inner surface of the element wire insulating layer 221 and fused to the conductor 21.

The element wire coating 22 is helically wound (laterally wound) around the conductor 21. In this embodiment, the element wire coating 22 is wound around the conductor 21 so that portions of the tape do not overlap each other. Specifically, the element wire coating 22 is wound by so-called butt winding in which end portions in the width direction of the element wire coating 22 abut each other. As a result, compared with the case where the winding method of the element wire coating 22 is lap winding in which the end portions in the width direction of the element wire coating 22 are overlapped while winding, the thickness of the element wire coating 22 is made uniform in the longitudinal direction. Thus, the electrical insulating property provided by the element wire coating 22 is made uniform in the longitudinal direction and miniaturization is achieved. Note that the winding method of the element wire coating 22 is not limited to butt winding; lap winding or longitudinal application is also acceptable. A plurality of element wire coatings 22 may be used to form the element wire coating 22 in multiple layers.

The element wire insulating layer 221 is made of, for example, an engineering plastic or a super engineering plastic having heat resistance and electrical insulating properties, such as polyimide (PI), polyether-ether-ketone (PEEK), or polyphenylene sulfide (PPS). The element wire insulating layer 221 is preferably a thermosetting resin such as thermosetting polyimide, but may be a thermoplastic resin. When the element wire insulating layer 221 is a thermoplastic resin, it is preferable that the element wire insulating layer 221 have a higher melting point than the inner element wire fusion-bonding layer 223.

The inner element wire fusion-bonding layer 223 is formed on an inner surface of the element wire insulating layer 221 and is fused to the conductor 21. The inner element wire fusion-bonding layer 223 is made of an engineering plastic or a super engineering plastic which is a thermoplastic resin having heat resistance and electrical insulating properties. For example, it is preferable that the melting point of the inner element wire fusion-bonding layer 223 be 250° C. or higher. When the inner element wire fusion-bonding layer 223 is made of a material having no melting point, it is preferable that the melt-processable temperature be 250° C. or higher. Specifically, the inner element wire fusion-bonding layer 223 is made of a material including a fluororesin, polyether-ether-ketone (PEEK), polyphenylene sulfide (PPS), thermoplastic polyimide (PI), or polyetherimide (PEI). As the fluororesin, for example, perfluoroethylene propylene copolymer (FEP), perfluoroalkoxy alkane polymer (PFA), polytetrafluoroethylene (PTFE), or ethylene-tetrafluoroethylene copolymer (ETFE) can be used. Since the bunch insulated wire 1 may be exposed to high temperatures due to heat generation by energization, it is desirable that the inner element wire fusion-bonding layer 223 not melt at high temperatures.

In manufacturing the bunch insulated wire 1 of this embodiment, first, the two insulated element wire portions 2 and the insulating tape 3 are prepared. Each insulated element wire portion 2 is obtained by winding the element wire coating 22 around the conductor 21 and then heating to fuse the inner element wire fusion-bonding layer 223 of the element wire coating 22 to the conductor 21. Then, the two insulated element wire portions 2 are laminated in the thickness direction in an attitude where the thickness directions coincide to form a laminate. Then, the insulating tape 3 is wound around the laminate, and by heating the whole, the fusion-bonding layer 32 and the two insulated element wire portions 2 are fused together. Thus, the bunch insulated wire 1 of this embodiment can be manufactured. Other aspects are the same as in the first embodiment.

### Operation and Effects of the Third Embodiment

Also in this embodiment, the same operations and effects as those of the first embodiment are obtained.

### Fourth Embodiment

A fourth embodiment of the present invention will be described with reference to FIG. 5. FIG. 5 is a cross-sectional view of the bunch insulated wire 1.

This embodiment is a form in which the element wire coating 22 is changed relative to the third embodiment. Specifically, the element wire coating 22 of this embodiment further includes an outer element wire fusion-bonding layer 222 formed on an outer side of the element wire insulating layer 221. That is, the element wire coating 22 of this embodiment is a tape in which fusion-bonding layers (that is, the inner element wire fusion-bonding layer 223 and the outer element wire fusion-bonding layer 222) are formed on both surfaces of the element wire insulating layer 221.

The outer element wire fusion-bonding layer 222 is made of an engineering plastic or a super engineering plastic which is a thermoplastic resin having heat resistance and electrical insulating properties. For example, it is preferable that the melting point of the outer element wire fusion-bonding layer 222 be 250° C. or higher. When the outer element wire fusion-bonding layer 222 is made of a material having no melting point, it is preferable that the melt-processable temperature be 250° C. or higher. Specifically, the outer element wire fusion-bonding layer 222 is made of a material including a fluororesin, polyether-ether-ketone (PEEK), polyphenylene sulfide (PPS), thermoplastic polyimide (PI), or polyetherimide (PEI). As the fluororesin, for example, perfluoroethylene propylene copolymer (FEP), perfluoroalkoxy alkane polymer (PFA), polytetrafluoroethylene (PTFE), or ethylene-tetrafluoroethylene copolymer (ETFE) can be used. Since the bunch insulated wire 1 may be exposed to high temperatures due to heat generation by energization, it is desirable that the outer element wire fusion-bonding layer 222 not melt at high temperatures. Note that, after fusion-bonding, the boundary of the outer element wire fusion-bonding layer 222 is not necessarily clearly observable; in FIG. 5, the contour position of the outer element wire fusion-bonding layer 222 before fusion-bonding is indicated by a chain double-dashed line.

The outer element wire fusion-bonding layers 222 of the plurality of insulated element wire portions 2 are fixed to each other by mutual fusion-bonding. Further, the outer element wire fusion-bonding layers 222 of the plurality of insulated element wire portions 2 are also fused to the fusion-bonding layer 32 of the insulating tape 3.

In manufacturing the bunch insulated wire 1 of this embodiment, first, the two insulated element wire portions 2 and the insulating tape 3 are prepared. Each insulated element wire portion 2 is obtained by winding the element wire coating 22 around the conductor 21 and then heating to fuse the inner element wire fusion-bonding layer 223 of the element wire coating 22 to the conductor 21. Then, the two insulated element wire portions 2 are laminated in the thickness direction in an attitude where the thickness directions coincide to form a laminate. Thereafter, by heating the laminate, the outer element wire fusion-bonding layers 222 of the two insulated element wire portions 2 are fused to each other. Thus, the relative positions of the two insulated element wire portions 2 are fixed. Next, the insulating tape 3 is wound around the two insulated element wire portions 2, and by heating the whole, the fusion-bonding layer 32 and the outer element wire fusion-bonding layers 222 of the two insulated element wire portions 2 are fused together. Thus, the bunch insulated wire 1 of this embodiment can be manufactured. Other aspects are the same as in the third embodiment.

### Operation and Effects of the Fourth Embodiment

Also in this embodiment, the same operations and effects as those of the third embodiment are obtained.

### Fifth Embodiment

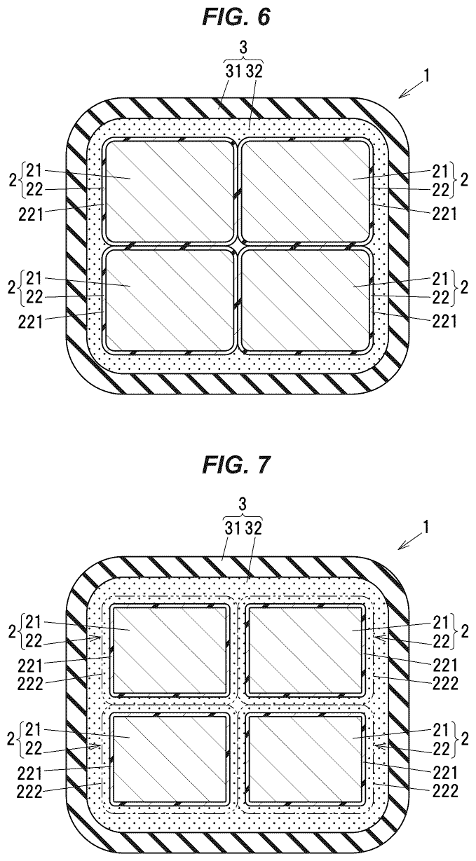

A fifth embodiment of the present invention will be described with reference to FIG. 6. FIG. 6 is a cross-sectional view of the bunch insulated wire 1.

This embodiment has the same basic configuration as the first embodiment, but the number of the insulated element wire portions 2 is four. The four insulated element wire portions 2 are arranged in two rows and two columns in the thickness direction and the width direction. Other aspects are the same as in the first embodiment. (Operation and Effects of the Fifth Embodiment)

Also in this embodiment, the same operations and effects as those of the first embodiment are obtained.

### Sixth Embodiment

A sixth embodiment of the present invention will be described with reference to FIG. 7. FIG. 7 is a cross-sectional view of the bunch insulated wire 1.

This embodiment has the same basic configuration as the second embodiment, but the number of the insulated element wire portions 2 is four. The four insulated element wire portions 2 are arranged in two rows and two columns in the thickness direction and the width direction. Other aspects are the same as in the second embodiment.

### Operation and Effects of the Sixth Embodiment

Also in this embodiment, the same operations and effects as those of the second embodiment are obtained.

### Seventh Embodiment

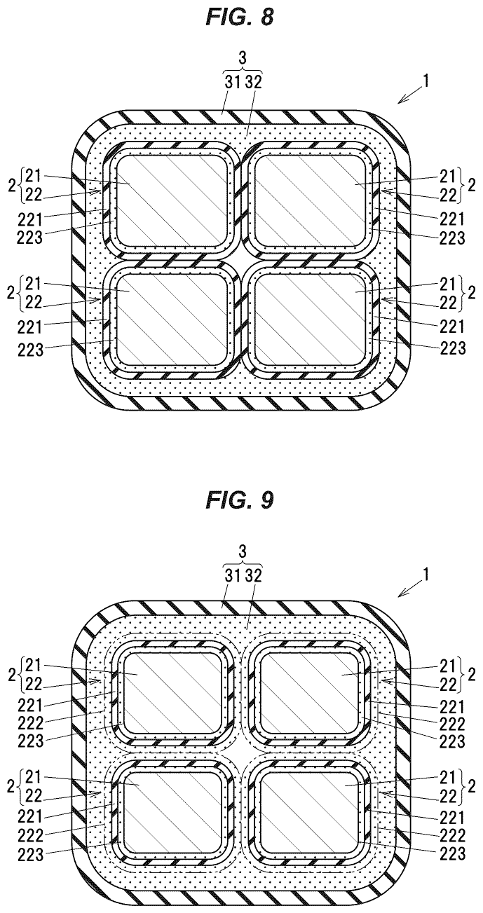

A seventh embodiment of the present invention will be described with reference to FIG. 8.

FIG. 8 is a cross-sectional view of the bunch insulated wire 1.

This embodiment has the same basic configuration as the third embodiment, but the number of the insulated element wire portions 2 is four. The four insulated element wire portions 2 are arranged in two rows and two columns in the thickness direction and the width direction. Other aspects are the same as in the third embodiment.

### Operation and Effects of the Seventh Embodiment

Also in this embodiment, the same operations and effects as those of the third embodiment are obtained.

### Eighth Embodiment

An eighth embodiment of the present invention will be described with reference to FIG. 9.

FIG. 9 is a cross-sectional view of the bunch insulated wire 1.

This embodiment has the same basic configuration as the fourth embodiment, but the number of the insulated element wire portions 2 is four. The four insulated element wire portions 2 are arranged in two rows and two columns in the thickness direction and the width direction. Other aspects are the same as in the fourth embodiment.

### Operation and Effects of the Eighth Embodiment

Also in this embodiment, the same operations and effects as those of the fourth embodiment are obtained.

### Ninth Embodiment

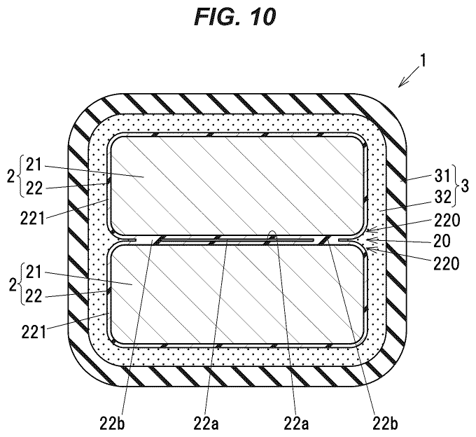

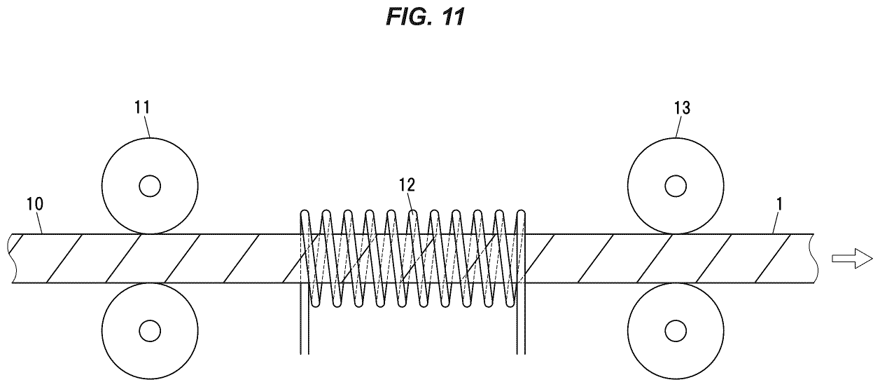

A ninth embodiment of the present invention will be described with reference to FIGS. 10 and 11. FIG. 10 is a cross-sectional view of the bunch insulated wire 1.

This embodiment has the same basic configuration as the first embodiment, but is a form in which the element wire coatings 22 of the two insulated element wire portions 2 are partially melted and bonded to each other. In FIG. 10, an example is shown in which the respective element wire coatings 22 of the two insulated element wire portions 2 have a bonding portion 22b formed by partial melting and bonding of the mutually facing surfaces 22a; however, the mutually facing surfaces 22a may be entirely melted and bonded.

Further, in this embodiment, the method for manufacturing the bunch insulated wire 1 is devised with respect to the heating step for fusion-bonding the insulating tape 3 to the two insulated element wire portions 2.

FIG. 11 is a schematic diagram for illustrating the heating step. In the heating step, an assembly 10 obtained by laterally winding the insulating tape 3 around a laminate consisting of the two laminated insulated element wire portions 2 is heated, and the fusion-bonding layer 32 of the insulating tape 3 is bonded to bonding targets. The heating step is carried out by sequentially running the assembly 10 through a preheating roll 11, an induction coil 12, and a post-heating roll 13.

The preheating roll 11 clamps the running assembly 10. At least a portion constituting the outer peripheral surface of the preheating roll 11 is made of a material having heat resistance and elasticity, such as fluororubber. The preheating roll 11 is pressed toward the running assembly 10 and heats the assembly 10. By passing through the preheating roll 11, the insulating tape 3 is temporarily bonded.

The induction coil 12 is for heating the assembly 10 (directly, the conductor 21) by an induction heating method. By running the assembly 10 so as to pass through the induction coil 12 through which a high-frequency alternating current flows, an eddy current is generated in the conductor 21 of the assembly 10, and Joule heat is generated. By this Joule heat, the fusion-bonding layer 32 of the insulating tape 3 is heated and melted.

The post-heating roll 13 clamps the running assembly 10 in the thickness direction of the assembly 10. At least a portion constituting the outer peripheral surface of the post-heating roll 13 is made of a material having heat resistance and elasticity, such as fluororubber. The post-heating roll 13 is pressed toward the running assembly 10 and heats the assembly 10. By passing through the post-heating roll 13, main bonding of the insulating tape 3 is performed while suppressing a temperature drop of the fusion-bonding layer 32 of the insulating tape 3. At this time, the fusion-bonding layer 32 of the insulating tape 3 enters at least a part of the recess 20. After the assembly 10 passes through the post-heating roll 13, the fusion-bonding layer 32 of the insulating tape 3 is cooled, and the fusion-bonding layer 32 of the insulating tape 3 is fused to the two insulated element wire portions 2.

In the heating step, the element wire insulating layers 221 of the two insulated element wire portions 2 are also heated, and by partial melting and mixing of portions thereof, the bonding portion 22b is formed. Here, the element wire insulating layer 221 is made of a thermosetting resin such as polyamide-imide (PAI) or polyimide (PI) as described above, and the glass transition temperature thereof is about 250 to 400° C. When such an element wire insulating layer 221 is heated in the heating step described above and exceeds the glass transition temperature, it softens and molecular motion occurs, and the volume expands, for example, by slightly less than 5%. Thereafter, by rapid cooling, minute uneven portions present at the interface between the element wire insulating layers 221 engage each other, and an anchor effect appears. Thus, favorable adhesiveness is obtained.

Furthermore, from a chemical viewpoint, it is understood as follows. In polyamide-imide (PAI), amide groups (—CONH—) and imide groups (—CO—N—CO—) exist in the molecule, and these contribute to formation of hydrogen bonds between molecules. In particular, a strong hydrogen bond is formed between N—H of an amide group and oxygen of a carbonyl group, which is considered to greatly contribute to inter-molecular adhesion. In addition, since polyamide-imide (PAI) contains aromatic rings, π-electron system interactions (π-π interactions) may appear, but the contribution of hydrogen bonding is considered to be dominant.

Also, in polyimide (PI), when unreacted amine groups or carbonyl groups remain, hydrogen bonds may be formed. Further, since polyimide (PI) contains many aromatic skeletons, π-π interactions readily occur between molecules. Furthermore, van der Waals forces are also considered to act based on a large contact area between polymer chains. By these interactions, stable adhesion is developed between the element wire insulating layers 221. Thus, the bunch insulated wire 1 of this embodiment can be manufactured. Other aspects are the same as in the first embodiment.

### Operation and Effects of the Ninth Embodiment

In the bunch insulated wire 1 of this embodiment, among the plurality of insulated element wire portions 2, adjacent insulated element wire portions 2 are bonded to each other by partial melting of the element wire coatings 22. Therefore, displacement between the plurality of insulated element wire portions 2 is more readily suppressed.

Further, in the method for manufacturing the bunch insulated wire 1 of this embodiment, by an induction heating method, the fusion-bonding layer 32 of the insulating tape 3 is bonded to each of the plurality of insulated element wire portions 2. Since the induction heating method has a fast heating rate, easy temperature control, and excellent local heating performance, productivity is improved. It is also possible to reduce the energy consumption required for manufacturing the bunch insulated wire 1.

Further, in the method for manufacturing the bunch insulated wire 1 of this embodiment, by an induction heating method, the fusion-bonding layer 32 of the insulating tape 3 is bonded to each of the plurality of insulated element wire portions 2, and at the same time, the element wire coatings 22 of adjacent insulated element wire portions 2 among the plurality of insulated element wire portions 2 are partially melted to bond the adjacent insulated element wire portions 2 to each other. Therefore, it becomes possible to manufacture, with high productivity, a bunch insulated wire 1 in which the relative positions of the plurality of insulated element wire portions 2 are unlikely to deviate. Other operations and effects are the same as those of the first embodiment.

### Experimental Example 1

Experimental Example 1 is an example in which heat resistance was evaluated for eight kinds of resins. Among these resins, those evaluated to have high heat resistance are suitably used as resins for the insulating tape 3 or the element wire coating 22.

A first resin is a PEI-based resin of a single layer serving as both the insulating layer and the fusion-bonding layer, specifically ULTEM (registered trademark) manufactured by SABIC Innovative Plastics.

A second resin is a TPI-based resin of a single layer serving as both the insulating layer and the fusion-bonding layer, specifically AURUM (registered trademark) manufactured by Mitsui Chemicals.

A third resin is an aromatic polyamide-based resin of a single layer serving as both the insulating layer and the fusion-bonding layer.

A fourth resin is a PI-based resin of a single layer serving as both the insulating layer and the fusion-bonding layer, specifically KAPTON 300H (registered trademark) manufactured by Toray DuPont.

A fifth resin is a laminated film in which an insulating layer made of a PI-based resin and a fusion-bonding layer made of an FEP-based resin are laminated, specifically KAPTON 150F (registered trademark) manufactured by Toray DuPont.

A sixth resin is a PEEK-based resin of a single layer serving as both the insulating layer and the fusion-bonding layer.

A seventh resin is a laminated film in which fusion-bonding layers made of a TPI-based resin are laminated on both surfaces of an insulating layer made of a PI-based resin, specifically Upilex VT (registered trademark) manufactured by Toray DuPont.

An eighth resin is a PI-based resin of a single layer serving as both the insulating layer and the fusion-bonding layer, specifically PIXEO (registered trademark) manufactured by Kaneka.

In the heat-resistance evaluation of each resin, thermogravimetric analysis (TGA) was performed by sampling 10 mg of each resin, and the temperature at which the weight decreased by 5% was taken as the T5 temperature [° C.] as an index of heat-resistance evaluation. As TGA conditions, the heating rate was 10° C./min, and air was supplied into the apparatus at 100 ml/min.

The results of the heat-resistance evaluation of each resin are shown in Table 1. In Table 1, those with a T5 temperature of less than 500° C. are indicated by “x”, those with a T5 temperature of 500° C. or higher and 550° C. or lower are indicated by “β”, and those with a T5 temperature exceeding 550° C. are indicated by “⊚”.

TABLE 1

| | | | | | | | | |
|---|---|---|---|---|---|---|---|---|
| Resin | PEI | TPI | Aromatic | PI | PI-FEP | PEEK | TPI-PI- | PI |
| System | | | Polyamide | | | | TPI | |
| Product | ULTEM | AURUM | — | Kapton | Kapton | — | Upilex VT | Pixeo |
| Name | | | | 300H | 150F | | | |
| Heat | ◯ | ⊚ | X | ⊚ | ◯ | ⊚ | ⊚ | X |
| Resistance | (Good) | (Excellent) | (Poor) | (Excellent) | (Good) | (Excellent) | (Excellent) | (Poor) |
| Evaluation | | | | | | | | |

From Table 1, it can be seen that a PEI-based resin, a TPI-based resin, a PI-based resin, and a PEEK-based resin, each of a single layer serving as both the insulating layer and the fusion-bonding layer, as well as a laminated film in which an insulating layer made of a PI-based resin and a fusion-bonding layer made of an FEP-based resin are laminated, and a laminated film in which fusion-bonding layers made of a TPI-based resin are laminated on both surfaces of an insulating layer made of a PI-based resin, have high heat resistance. However, attention must be paid to product differences with respect to PI-based resins. From the viewpoint of heat resistance, a TPI-based resin or a PEEK-based resin of a single layer is preferable. It can also be seen that the laminated film of a PI-based insulating layer and an FEP-based fusion-bonding layer, and the laminated film of a PI-based insulating layer with TPI-based fusion-bonding layers on both surfaces, have high heat resistance.

### Experimental Example 2

Experimental Example 2 is an example in which the adhesiveness between the insulated element wire portion 2 and the insulating tape 3 was evaluated when various tapes were used as the insulating tape 3.

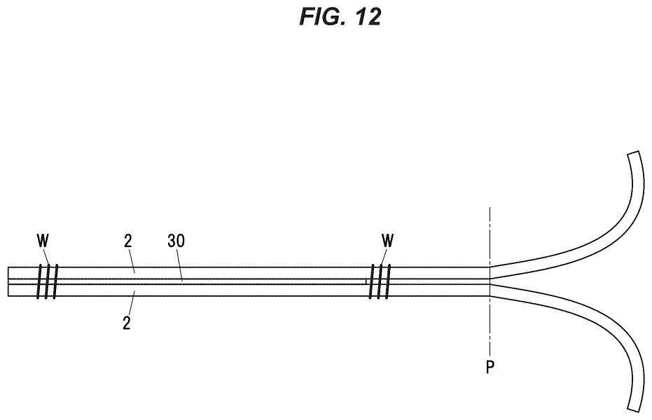

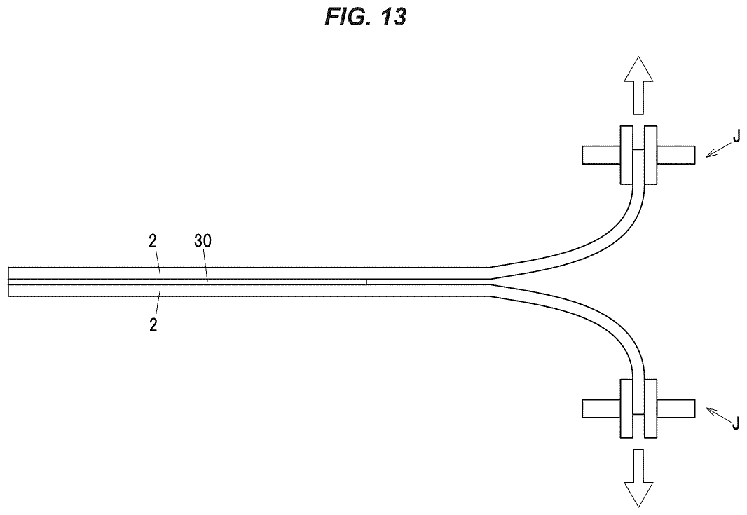

FIG. 12 is a first figure for explaining a method of evaluating adhesiveness, and FIG. 13 is a second figure for explaining a method of evaluating adhesiveness.

The method of evaluating adhesiveness will be described in detail below.

First, as shown in FIG. 12, after removing bending set of the insulated element wire portion 2 and cutting to a length of 80 mm, a position P at 20 mm from the tip was bent perpendicularly using a tool such as pliers. Then, portions on the base-end side from the bent portions of the two insulated element wire portions 2 were arranged in parallel, and a tape 30 of a length of 40 mm was interposed therebetween by longitudinal application, and two predetermined positions on the base-end side from the bent portions were tied with wires W. At this time, the two insulated element wire portions 2 and the tape 30 were aligned at the base-end position (the left end position in FIG. 12). The two insulated element wire portions 2 were arranged in an attitude of a bell shape in which their bent portions separate from each other toward the tip side. Then, by an induction heating method, the tape 30 was bonded to the insulated element wire portions 2, and the wires W were removed.

Thereafter, as shown in FIG. 13, the tip portions of the two insulated element wire portions 2 were gripped by a jig J and pulled at a speed of 25 mm/min to the sides separating from each other, and adhesiveness was evaluated based on evaluation criteria (see the explanation of the ⊚, ∘, and × marks described later).

In this Experimental Example 2, cases were evaluated in which the element wire coating 22 of the insulated element wire portion 2 was an enamel coating (specifically, a PAI enamel coating) and cases in which the element wire coating 22 of the insulated element wire portion 2 was a tape (hereinafter referred to as an element wire tape), while changing the kind of the tape 30.

In examples in which the element wire coating 22 of the insulated element wire portion 2 was an enamel coating, the thickness and width of the conductor 21 were 1.15 mm and 6.50 mm, respectively, and the thickness of the element wire coating 22 was 10 μm. In the examples with an enamel coating, as the tape 30 was bonded to the two insulated element wire portions 2, the induction heating method was used, and separate examples were prepared with the induction heating temperature of 365° C. and 385° C., respectively. The fusion-bonding heating temperature means the temperature of the insulated element wire portion 2 heated by passage through the induction coil 12.

In examples in which the element wire coating 22 of the insulated element wire portion 2 was an element wire tape, the thickness and width of the conductor 21 were 1.15 mm and 6.50 mm, respectively; the element wire tape was Kapton 150F, with a thickness of 37.5 μm and a width of 12 mm, and was laterally wound around the conductor 21 with a ½ lap. Also, the induction heating temperature for bonding the element wire tape to the conductor 21 and the induction heating temperature for bonding the tape 30 to the two insulated element wire portions 2 were both 365° C.

The tapes 30 used were of the same kinds as the various tapes used in Experimental Example 1. Here, for the tapes 30 made of ULTEM and aromatic polyamide, two different thicknesses were prepared. The width of each tape 30 was 6.5 mm.

The results of adhesiveness evaluation are shown in Table 2 below. In the adhesiveness column of Table 2, examples in which the two insulated element wire portions 2 could be peeled by manual force are indicated by “x”, and examples in which they could not be peeled by manual force are indicated by “∘” or “⊚”. Here, in the case where, after the test, when the jig J was removed from the two insulated element wire portions 2, the shapes of the two insulated element wire portions 2 elastically returned to the shapes before the test (that is, the shape shown in FIG. 12), the mark “∘” was given, and in the case where the shapes of the two insulated element wire portions 2 plastically deformed between before and after the test, the mark “⊚” was given. Examples marked “⊚” required strong force to peel the two insulated element wire portions 2 and had the best adhesiveness. In Table 2, the symbol “−” means that the test was not conducted.

TABLE 2

| Tape | Resin System | | PEI | | TPI | Aromatic Polyamide | | PI | PI-FEP | [symbol] |
|---|---|---|---|---|---|---|---|---|---|---|
| | Product Name | | ULTEM | | AURUM | — | | Kapton 300H | Kapton 150F | [symbol] |
| | Thickness | | 50 μm | 10 μm | 50 μm | 50 μm | 100 μm | 80 μm | 37.5 μm | [symbol] |
| Adhesion | Wire | Heating | ⊚ | ⊚ | ⊚ | — | — | ◯ | ⊚ | [symbol] |
| | coating: | temperature | (Excellent) | (Excellent) | (Excellent) | | | (Good) | (Excellent) | |
| | Enamel | 365° C. | | | | | | | | |
| | coating | | | | | | | | | |
| | | Heating | ⊚ | ⊚ | ⊚ | — | — | ⊚ | ◯ | ( [symbol] |
| | | temperature | (Excellent) | (Excellent) | (Excellent) | | | (Excellent) | (Good) | |
| | | 385° C. | | | | | | | | |
| | Wire | Heating | ◯ | — | X | ⊚ | ⊚ | X | — | [symbol] |
| | coating: | temperature | (Good) | | (Poor) | (Excellent) | (Excellent) | (Poor) | | |
| | Tape on | 365° C. | | | | | | | | |
| | bare | | | | | | | | | |
| | wire | | | | | | | | | |

[symbol]

indicates data missing or illegible when filed

From Table 2, it can be seen that, regardless of whether the element wire coating 22 is an enamel coating or an element wire tape, high adhesiveness is obtained when the tape 30 is constituted of a single-layer PEI-based resin. Particularly, in the examples in which the element wire coating 22 was an enamel coating, it can be seen that very high adhesiveness is obtained. From the results of Experimental Example 1 described above, it can be seen that heat resistance is also ensured for the single-layer PEI-based resin. That is, the tape 30 made of a single-layer PEI-based resin is excellent from both viewpoints of heat resistance and adhesiveness.

From Table 2, in the examples in which the element wire coating 22 was an enamel coating, it can be seen that adhesiveness is readily ensured when the tape 30 is constituted of a single-layer TPI-based resin. From the results of Experimental Example 1 described above, it can be seen that heat resistance is also ensured for the single-layer TPI-based resin. That is, the tape 30 made of a single-layer TPI-based resin is excellent from both viewpoints of heat resistance and adhesiveness.

From Table 2, in the examples in which the element wire coating 22 was an element wire tape, it can be seen that adhesiveness is readily ensured when the tape 30 is constituted of a single-layer aromatic polyamide-based resin. However, from the results of Experimental Example 1 described above, since a single-layer aromatic polyamide-based resin has low heat resistance, attention is required regarding the use environment (temperature environment).

From Table 2, in the examples in which the element wire coating 22 was an enamel coating, it can be seen that adhesiveness is readily ensured when the tape 30 is a single-layer PI-based resin. When the tape 30 is a single-layer PI-based resin, it is preferable that the thickness of the tape 30 exceed 50 μm. However, attention is required because adhesiveness may vary depending on the heating temperature when bonding the tape 30 to the two insulated element wire portions 2. Further, as described in Experimental Example 1 above, since the heat resistance of a single-layer PI-based resin may vary depending on the type, attention is required from both viewpoints of heat resistance and adhesiveness.

From Table 2, in the examples in which the element wire coating 22 was an enamel coating, it can be seen that adhesiveness is readily ensured when the tape 30 is a laminated film in which an insulating layer made of a PI-based resin and a fusion-bonding layer made of an FEP-based resin are laminated. However, attention is required because adhesiveness may vary depending on the heating temperature when bonding the tape 30 to the two insulated element wire portions 2. From the results of Experimental Example 1 described above, it can be seen that the laminated film of an insulating layer made of a PI-based resin and a fusion-bonding layer made of an FEP-based resin also ensures heat resistance. That is, in the examples in which the element wire coating 22 was an enamel coating, the tape 30 formed as a laminated film of an insulating layer made of a PI-based resin and a fusion-bonding layer made of an FEP-based resin is preferable from both viewpoints of heat resistance and adhesiveness.

From Table 2, in the examples in which the element wire coating 22 was an enamel coating, in the case where the tape 30 was a single-layer PEEK-based resin and the heating temperature for bonding to the two insulated element wire portions 2 was 385° C., adhesiveness was readily ensured. From the results of Experimental Example 1 described above, it can be seen that heat resistance is also ensured for the single-layer PEEK-based resin. That is, the tape 30 made of a single-layer PEEK-based resin is excellent from both viewpoints of heat resistance and adhesiveness, although attention to the heating temperature when bonding the tape 30 to the two insulated element wire portions 2 is required.

From Table 2, in the examples in which the element wire coating 22 was an enamel coating, in the case where the tape 30 was a laminated film in which fusion-bonding layers made of a TPI-based resin are laminated on both surfaces of an insulating layer made of a PI-based resin (particularly when the heating temperature for bonding to the two insulated element wire portions 2 was 365° C.), adhesiveness was readily ensured. From the results of Experimental Example 1 described above, it can be seen that the laminated film in which fusion-bonding layers made of a TPI-based resin are laminated on both surfaces of an insulating layer made of a PI-based resin also ensures heat resistance. That is, in the examples in which the element wire coating 22 was an enamel coating, the tape 30 formed as a laminated film in which fusion-bonding layers made of a TPI-based resin are laminated on both surfaces of an insulating layer made of a PI-based resin is excellent from both viewpoints of heat resistance and adhesiveness.

### Experimental Example 3

Experimental Example 3 is an example in which the adhesiveness between the two insulated element wire portions 2 was evaluated for the bunch insulated wire 1 according to the ninth embodiment.

The adhesiveness was evaluated by a method similar to Experimental Example 2. Details are given below.

In this Experimental Example 3, similarly to Experimental Example 2, first, after removing bending set of the insulated element wire portion 2 and cutting to a length of 80 mm, a position 20 mm from the tip was bent perpendicularly using a tool such as pliers. Then, portions on the base-end side from the bent portions of the two insulated element wire portions 2 were arranged in parallel, and two predetermined positions on the base-end side from the bent portions were tied with wires W. At this time, the two insulated element wire portions 2 were aligned at the base-end position. Here, the difference from Experimental Example 2 is that no interposed tape (reference numeral 30 in FIG. 12) was interposed between the two insulated element wire portions 2. The two insulated element wire portions 2 were arranged in an attitude of a bell shape in which their bent portions separate from each other toward the tip side. Then, by an induction heating method at an induction heating temperature of 385° C., the element wire coatings 22 of the two insulated element wire portions 2 were bonded to each other at portions on the base-end side from the bent portions (that is, the parallel portions), and the wires W were removed.

Thereafter, the tip portions of the two insulated element wire portions 2 were pulled to the sides separating from each other at a speed of 25 mm/min using a jig J, and the adhesiveness was evaluated according to the evaluation criteria described in Experimental Example 2 (see the explanation of the ⊚, ∘, and × marks above).

The insulated element wire portions 2 used in this example were prepared by forming an element wire coating 22 made of polyamide-imide with a thickness of 10 μm around a conductor 21 having a thickness of 1.15 mm and a width of 6.50 mm.

As a result of the test, the adhesiveness evaluation was “∘”. That is, in a configuration in which portions of the element wire coatings 22 are melted and bonded to each other as in the ninth embodiment, it was confirmed that adhesiveness between the insulated element wire portions 2 is favorable.

### SUMMARY OF THE EMBODIMENTS

Next, technical ideas grasped from the embodiments described above will be described using the reference numerals in the embodiments. However, the reference numerals in the following description do not limit the constituent elements in the claims to the members specifically shown in the embodiments.
[1] A bunch insulated wire 1 including: a plurality of insulated element wire portions 2 each having a conductor 21 and an element wire coating 22 that surrounds the conductor 21; and an insulating tape 3 that collectively surrounds the plurality of insulated element wire portions 2, the insulating tape 3 having an insulating layer 31 having electrical insulating properties and a fusion-bonding layer 32 fused to the plurality of insulated element wire portions 2, the fusion-bonding layer 32 being made of an engineering plastic or a super engineering plastic.
[2] The bunch insulated wire 1 as described by [1], wherein the fusion-bonding layer 32 is made of a material including a fluororesin, PEEK, PPS, PI, or PEI.
[3] The bunch insulated wire 1 as described by [1] or [2], wherein the element wire coating 22 includes the element wire insulating layer 221 and an outer element wire fusion-bonding layer 222 formed on an outer side of the element wire insulating layer 221, and the outer element wire fusion-bonding layers 222 of the plurality of insulated element wire portions 2 are fused to each other.
[4] The bunch insulated wire 1 as described by any one of [1] to [3], wherein the insulating tape 3 is formed so that its portions do not overlap each other.
[5] The bunch insulated wire 1 as described by any one of [1] to [4], wherein the plurality of insulated element wire portions 2 are not more than four.
[6] The bunch insulated wire 1 as described by [1], wherein the element wire coating 22 is constituted by an enamel coating made of PAI or PI, and the insulating tape 3 is a single layer serving as both the insulating layer 31 and the fusion-bonding layer 32 and is made of a PEEK-based resin, a PEI-based resin, or a TPI-based resin.
[7] The bunch insulated wire 1 as described by [1], wherein the element wire coating 22 is constituted by an enamel coating made of PAI or PI, the insulating tape 3 has a multilayer structure including, as separate layers, the insulating layer 31 and the fusion-bonding layer 32 formed on an inner surface of the insulating layer 31, the insulating layer 31 is made of a PI-based resin, and the fusion-bonding layer 32 is made of a TPI-based resin or an FEP-based resin.
[8] The bunch insulated wire 1 as described by any one of [1] to [7], wherein, among the plurality of insulated element wire portions 2, adjacent insulated element wire portions 2 are bonded to each other by partial melting of the element wire coatings 22.
[9] A method for manufacturing a bunch insulated wire 1, the method including: preparing a plurality of insulated element wire portions 2 each having a conductor 21 and an element wire coating 22 that surrounds the conductor 21, and an insulating tape 3 having an insulating layer 31 having electrical insulating properties and a fusion-bonding layer 32 made of an engineering plastic or a super engineering plastic, the fusion-bonding layer 32 being fused to the plurality of insulated element wire portions 2; laterally winding the insulating tape 3 so as to collectively surround the plurality of insulated element wire portions 2; and, by an induction heating method, bonding the fusion-bonding layer 32 of the insulating tape 3 to each of the plurality of insulated element wire portions 2.
[10] The method for manufacturing a bunch insulated wire 1 as described by [9], wherein, by the induction heating method, while bonding the fusion-bonding layer 32 of the insulating tape 3 to each of the plurality of insulated element wire portions 2, the element wire coatings 22 of the adjacent insulated element wire portions 2 among the plurality of insulated element wire portions 2 are partially melted to bond the adjacent insulated element wire portions 2 to each other.

Although embodiments of the present invention have been described above, the embodiments described above do not limit the invention according to the claims. It should also be noted that not all combinations of features described in the embodiments are necessarily essential means for solving the problems of the invention. The present invention can also be implemented with appropriate modifications without departing from the spirit thereof.

1. A bunch insulated wire comprising:
a plurality of insulated element wire portions each having a conductor and an element wire coating that surrounds the conductor; and
an insulating tape that collectively surrounds the plurality of insulated element wire portions,
wherein the insulating tape has an insulating layer having electrical insulating properties and a fusion-bonding layer fused to the plurality of insulated element wire portions, and wherein the fusion-bonding layer is made of an engineering plastic or a super engineering plastic.

2. The bunch insulated wire according to claim 1, wherein the fusion-bonding layer is made of a material including a fluororesin, PEEK, PPS, PI, or PEI.

3. The bunch insulated wire according to claim 1, wherein the element wire coating includes an element wire insulating layer and an outer element wire fusion-bonding layer formed on an outer side of the element wire insulating layer, and the outer element wire fusion-bonding layers of the plurality of insulated element wire portions are fused to each other.

4. The bunch insulated wire according to claim 1, wherein the insulating tape is formed so that its portions do not overlap each other.

5. The bunch insulated wire according to claim 1, wherein the plurality of insulated element wire portions are not more than four.

6. The bunch insulated wire according to claim 1, wherein the element wire coating is constituted by an enamel coating made of PAI or PI, and
wherein the insulating tape is a single layer serving as both the insulating layer and the fusion-bonding layer and is made of a PEEK-based resin, a PEI-based resin, or a TPI-based resin.

7. The bunch insulated wire according to claim 1, wherein the element wire coating is constituted by an enamel coating made of PAI or PI,
wherein the insulating tape has a multilayer structure including, as separate layers, the insulating layer and the fusion-bonding layer formed on an inner surface of the insulating layer, and
wherein the insulating layer is made of a PI-based resin, and the fusion-bonding layer is made of a TPI-based resin or an FEP-based resin.

8. The bunch insulated wire according to claim 1, wherein, among the plurality of insulated element wire portions, adjacent insulated element wire portions are bonded to each other by partial melting of the element wire coatings.

9. A method for manufacturing a bunch insulated wire, the method comprising:
preparing a plurality of insulated element wire portions each having a conductor and an element wire coating that surrounds the conductor, and an insulating tape having an insulating layer having electrical insulating properties and a fusion-bonding layer made of an engineering plastic or a super engineering plastic, the fusion-bonding layer being fused to the plurality of insulated element wire portions;
laterally winding the insulating tape so as to collectively surround the plurality of insulated element wire portions; and
by an induction heating method, bonding the fusion-bonding layer of the insulating tape to each of the plurality of insulated element wire portions.

10. The method for manufacturing a bunch insulated wire according to claim 9, wherein, by the induction heating method, while bonding the fusion-bonding layer of the insulating tape to each of the plurality of insulated element wire portions, the element wire coatings of the adjacent insulated element wire portions among the plurality of insulated element wire portions are partially melted to bond the adjacent insulated element wire portions to each other.
